(19) United States
(12) Patent Application Publication
(10) Pub. No.: US 2025/0282144 A1
(43) Pub. Date: Sep. 11, 2025

(54) LIQUID STORAGE BOTTLE AND RECORDING DEVICE

(71) Applicant: CANON KABUSHIKI KAISHA, Tokyo (JP)

(72) Inventor: AKANE HISANAGA, Tokyo (JP)

(21) Appl. No.: 19/070,127

(22) Filed: Mar. 4, 2025

(30) Foreign Application Priority Data
Mar. 5, 2024 (JP) 2024-032737

(51) Int. Cl. B41J 2/175

(52) U.S. Cl. CPC B41J 2/17509; B41J 2/17553

(57) ABSTRACT

An ink refill system with an ink storage bottle in which, when ink is supplied from an ink storage bottle 20 to a storage chamber 100 of a liquid tank 16, the flow path resistance of a second flow path portion 192 through which the ink flows is less than the flow path resistance of a first flow path portion 191 through which air flows of the two flow path portions provided in a nozzle 110 of the ink storage bottle 20.

### BACKGROUND

### Field

The present disclosure relates to a recording device including an ink storage bottle that stores ink and a liquid tank to which the ink storage bottle is connected.

### Description of the Related Art

Some liquid tanks used in liquid discharge devices, such as ink jet recording devices, can be supplied with liquids from separately prepared ink storage bottles. In such a liquid discharge device, the ink storage bottle is attached to the liquid tank when ink is supplied to the liquid tank. When the ink storage bottle is attached to the liquid tank, the interior of the ink storage bottle communicates with the interior of the liquid tank through a flow path provided in the ink storage bottle. Printing liquids, such as ink, can be supplied from the ink storage bottle to the liquid tank by pressing the side wall of the ink storage unit of the ink storage bottle with the ink storage bottle attached to the liquid tank.

In Japanese Patent Laid-Open No. 2020-189454, ink is supplied from the ink storage bottle to the liquid tank by using a so-called chicken feed method. The ink storage bottle has two flow paths through which a liquid or air flows, and gas-liquid exchange can be performed by causing air to flow through one flow path and ink to flow through the other flow path. The ink level in the liquid tank rises when the ink flows into the liquid tank, and the air flow is blocked when the ink level reaches the opening of the flow path through which air flows in the ink storage bottle. As a result, the ink flow from the ink storage bottle to the liquid tank is stopped.

In the chicken feed method described above, after the ink storage bottle is attached to the liquid tank, the flow rate of supplying ink from the ink storage bottle to the liquid tank may be insufficient, and accordingly, the refill time becomes longer.

In Japanese Patent Laid-Open No. 2020-189454, the supply of ink from the ink storage bottle to the liquid tank is performed by gas-liquid exchange through the two flow paths provided in the nozzle of the ink storage bottle. The lengths of the two flow paths in the direction of a liquid flow are identical to each other, and the cross-sectional shapes and the cross-sectional areas are also identical to each other.

In addition, since the nozzle has a shape that projects from the storage unit of the ink storage bottle, the two flow paths are long tubes. As a result, there is a concern that the amount of ink supplied from the ink storage bottle to the liquid tank per unit time reduces, and accordingly, the refill time becomes longer.

### SUMMARY

The present disclosure addresses the problems described above and increases the refill speed of the ink storage bottle that supplies ink to the liquid tank and reduces the refill time.

Some exemplary embodiments, features, and aspects of the present disclosure have the following structure.

A liquid storage bottle that supplies a liquid to a recording device including a recording head that discharges the liquid, and a liquid tank that includes a storage unit that stores the liquid supplied to the recording head and an opening portion through which the liquid is supplied. The liquid storage bottle includes
a bottle main body that stores the liquid;
and a liquid supply unit including a second flow path through which the liquid flows from the bottle main body to the liquid tank, the second flow path being connected to the opening portion of the liquid tank, and a first flow path through which a gas flows from the liquid tank to the bottle main body,
in which a flow path resistance of the first flow path is greater than a flow path resistance of the second flow path.

According to another exemplary embodiment, an ink refill system has an ink storage bottle in which, when ink is supplied from an ink storage bottle to a storage chamber of a liquid tank, the flow path resistance of a second flow path portion through which the ink flows is less than the flow path resistance of a first flow path portion through which air flows of the two flow path portions provided in a nozzle of the ink storage bottle.

Further features of the present disclosure will become apparent from the following description of exemplary embodiments with reference to the attached drawings.

### BRIEF DESCRIPTION OF THE DRAWINGS

FIG. 1 is a perspective view of a recording device according to a first embodiment.

FIG. 2 is a side view illustrating a main portion of the recording device according to the first embodiment.

FIG. 3 is a perspective view illustrating a state in which a liquid is supplied to the recording device illustrated in FIG. 1.

FIG. 4 is a diagram illustrating the component structure of an ink storage bottle according to the first embodiment.

FIG. 5 is a cross-sectional view of a nozzle main body illustrated in FIG. 4.

FIG. 6 is a cross-sectional view illustrating a state in which the liquid is supplied in the first embodiment.

FIGS. 7A to 7D are cross-sectional views of the nozzle main body according to the first embodiment.

FIGS. 8A to 8L are plan views of a base end portion of a nozzle according to the first embodiment.

FIGS. 9A to 9D are plan views of a base end portion of a nozzle according to a second embodiment.

FIGS. 10A to 10H are cross-sectional views of a nozzle main body according to a third embodiment.

FIGS. 11A to 11E are cross-sectional views of a nozzle main body according to a fourth embodiment.

FIGS. 12A to 12D are cross-sectional views of the nozzle main body according to the fourth embodiment.

FIGS. 13A to 13H are front views of the nozzle main body according to the fourth embodiment.

FIGS. 14A and 14B are cross-sectional views of a nozzle main body according to a fifth embodiment.

FIGS. 15A to 15C are front views of the nozzle main body according to the fifth embodiment.

FIGS. 16A to 16D are front views of the leading end of a nozzle according to the fifth embodiment.

FIGS. 17A to 17G are cross-sectional views of a nozzle main body according to a sixth embodiment.

FIG. 18A illustrates a plan view of the leading end of a nozzle according to the sixth embodiment, and FIGS. 18B and 18C illustrate a front view of a nozzle main body according to the sixth embodiment.

FIGS. 19A, 19C, 19E, and 19G are plan views of the leading end of a nozzle according to a seventh embodiment and FIGS. 19B, 19D, 19F, and 19H illustrate the shapes of openings of an injection portion according to the seventh embodiment.

FIGS. 20A to 20F are plan views of the leading end of a nozzle according to an eighth embodiment.

### DESCRIPTION OF THE EMBODIMENTS

Various exemplary embodiments, features, and aspects of the present disclosure will be described in detail below with reference to the drawings. However, the dimensions, the materials, the shapes, the relative arrangements, and the like of components described in the present embodiment are not intended to limit the scope of the present disclosure to only those unless otherwise specified.

In addition, unless otherwise specified, the materials and the shapes of the components previously described in the text will remain the same in subsequent descriptions.

### Structure of Device

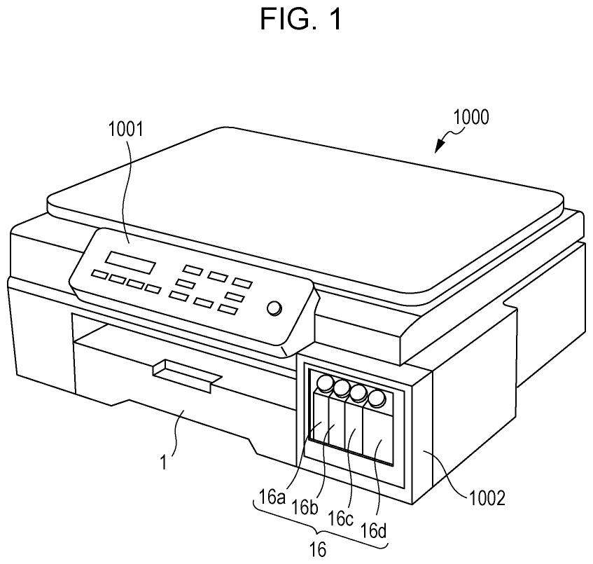

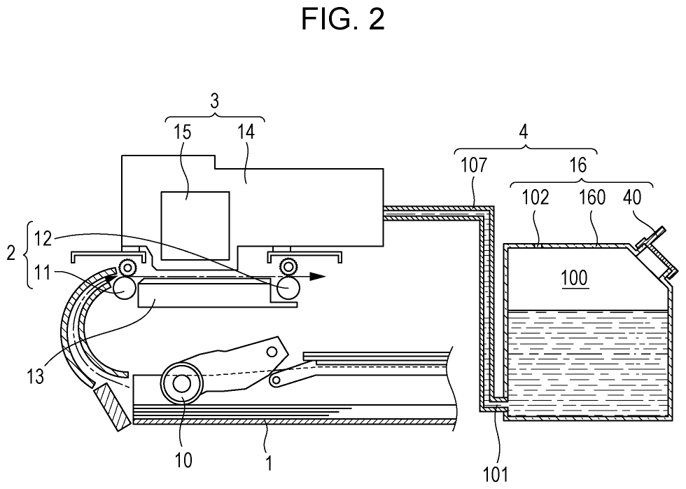

FIG. 1 is a perspective view of an ink jet recording device according to an embodiment of the present disclosure. FIG. 2 is a side view schematically illustrating a main portion of the ink jet recording device according to the present embodiment.

An ink jet recording device 1000, which is also referred to below as a recording device, includes a first feeding unit 1, a second feeding unit 2, a recording unit 3, and a liquid supply unit 4. The first feeding unit 1 includes a feeding roller 10 that separates a recording medium from a bundle of loaded recording media one by one and supplies the separated medium to the second feeding unit 2. The second feeding unit 2 includes a conveying roller 11, provided downstream of the first feeding unit 1 in the conveying direction of the recording media, that conveys the recording medium fed from the feeding roller 10, and a paper discharge roller 12. A platen 13 that supports, from below, the recording medium conveyed by the second feeding unit 2 is provided between the conveying roller 11 and the paper discharge roller 12.

The recording unit 3 includes a carriage 14, provided at a position facing the platen 13, that moves reciprocally in a direction orthogonal to the conveying direction of the recording media and a recording head 15, mounted on the carriage 14, that has a plurality of rows of discharge ports each having a plurality of discharge ports. The recording head 15 discharges ink of different colors from the individual discharge port rows by energy generating elements corresponding to the discharge ports being driven in accordance with recording data and records a color image on the recording medium supported by the platen 13.

The liquid supply unit 4 includes a liquid tank 16, which is a semi-transparent or transparent container, and a flexible supply tube 107 that connects the liquid tank 16 and the recording head 15 to each other. In the present embodiment, four colors of ink (for example, cyan, magenta, yellow, and black) are used as the liquid, and four liquid tanks 16a to 16d that store the four colors of ink are provided as the liquid tank 16. The liquid is not limited to ink and may also be a recording liquid, a fixing solution, a resist, or the like.

The liquid tank 16 includes a cap 40, attachable to the tank body 160, that hermetically seals the tank body 160 incorporating a storage chamber 100 that stores the liquid and the storage chamber 100. A supply port 101 connected to the supply tube 107 is provided in a lower portion of the tank body 160, and an atmospheric communication port 102 through which the storage chamber 100 communicates with the atmosphere is provided in the upper surface of the tank body 160. When the liquid is discharged from the recording head 15, the negative pressure in the recording head 15 increases, and accordingly, the liquid stored in the storage chamber 100 of the liquid tank 16 is supplied from the supply port 101 to the recording head 15 through the supply tube 107. At this time, the same amount of gas as the liquid supplied to the recording head 15 flows into the storage chamber 100 in the liquid tank 16 through the atmospheric communication port 102.

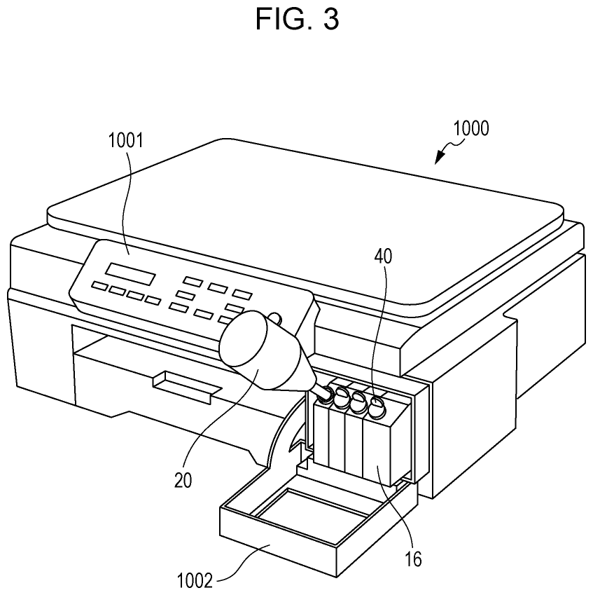

FIG. 3 is a perspective view illustrating a state in which the liquid is supplied to the recording device illustrated in FIG. 1. When the remaining amount of the liquid in the storage chamber 100 is detected to be equal to or smaller than a certain amount by the remaining amount detection unit (not illustrated) provided in the liquid tank 16, an indication prompting the user to supply the liquid to the liquid tank 16 is displayed on a display unit 1001 of the recording device 1000. The user tilts and opens a tank cover 1002 provided on the front surface of the recording device 1000 forward, removes the cap 40 attached to the liquid tank 16 to which the liquid is supplied, and exposes an opening portion 18 as a receiving portion to which the liquid is supplied. The opening portion 18 has an inclined surface that is inclined with respect to the horizontal direction and the vertical direction with the recording device 1000 installed in a normal use state, and the opening portion 18 is formed in the inclined surface. Then, the liquid is supplied to the liquid tank 16 through the exposed opening portion 18 by use of the ink storage bottle 20 that stores the liquid to be supplied. It should be noted that a plurality of types (four types in the present embodiment) of ink storage bottles 20 may be prepared in advance depending on the number of colors of the liquid (ink) used. Color information of the stored liquid (ink) is indicated on each of the ink storage bottles 20. The user selects an ink storage bottle 20 that stores the liquid to be supplied from the plurality of prepared ink storage bottles 20 in accordance with the indication on the display unit 1001 and the color information displayed on the liquid tank 16.

### Structure of Bottle

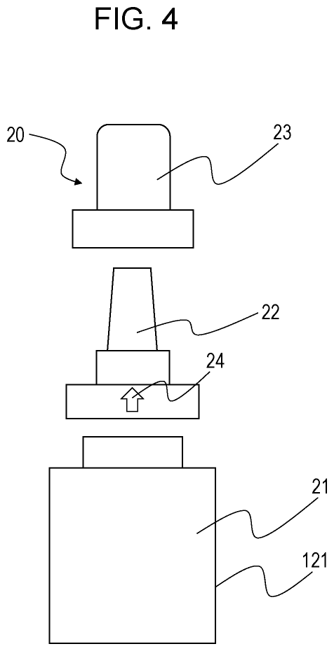

FIG. 4 is a diagram illustrating the component structure of the ink storage bottle 20, which is a liquid container for supplying a liquid to the liquid tank 16. The ink storage bottle 20 includes a bottle main body 21 that stores the liquid, a nozzle main body 22 connected to the bottle main body 21, and a bottle cap 23 attached to the nozzle main body 22. The nozzle main body 22 has the function of serving as an outlet through which the liquid stored in the bottle main body 21 is discharged to the outside. The bottle cap 23 shields the inside of the ink storage bottle 20 from the outside by being attached to the nozzle main body 22. The nozzle main body 22 is attachable to and detachable from the bottle main body 21 and is connected with a screwed manner. It should be noted that the nozzle main body 22 may be formed integrally with the bottle main body 21. In the integral structure, for example, it is possible to use a method that seals them with a flexible component therebetween or a method that melts and connects the bottle main body 21 and the nozzle main body 22 made of a resin. The bottle cap 23 is a single component and is cylindrical in shape. The bottle cap 23 is attachable to and detachable from the nozzle main body 22. The bottle cap 23 is attachable to and detachable from the bottle main body 21 via the nozzle main body 22.

### Structure of Nozzle

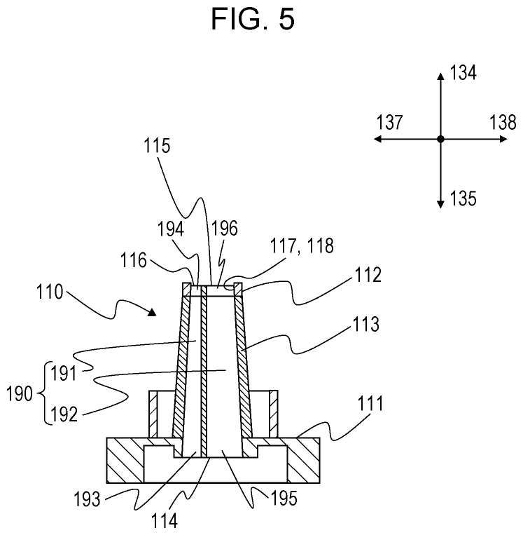

FIG. 5 is a cross-sectional view of the nozzle main body 22. As illustrated in FIG. 5, the nozzle 110 projects to a first orientation side 134 from the outer surface of a bottom wall 111 of a base end portion of the nozzle main body 22. That is, the nozzle 110 projects to the first orientation side 134 from the bottle main body 21 through the nozzle main body 22 with the nozzle main body 22 attached to the bottle main body 21. The nozzle 110 may project to a second orientation side 135 from the bottom wall 111 while projecting to the first orientation side 134 from the bottom wall 111. In this case, the nozzle is provided so as to pass through the bottom wall 111 of the base end portion.

The nozzle 110 is substantially cylindrical in shape. The nozzle 110 has an outer circumferential surface having an annular cross section. A portion of the outer circumferential surface is tapered in shape and inclined in a direction in which the diameter of the outer circumferential circle decreases toward the leading end portion 115 of the nozzle 110 from the bottom wall 111. Such a shape enables the nozzle 110 to be smoothly inserted into the tank sequentially from the distal end portion away from the bottle main body 21. However, the outer circumferential surface of the nozzle 110 may extend vertically so as to have the same diameter of the outer circumferential surface from the bottom wall 111 to the leading end. Alternatively, the nozzle may also be, for example, square cylindrical in shape instead of cylindrical.

The nozzle 110 has a first flow path 191 and a second flow path 192 as flow paths 190 through which ink or air flows. The first flow path 191 and the second flow path 192 pass through the nozzle main body 22 along the first orientation side 134. The first flow path 191 and the second flow path 192 extend to the first orientation side 134 but may also be curved. The lengths of the first flow path 191 and the second flow path 192 in the direction of an ink flow may be substantially the same or be different. In addition, the cross-sectional shapes and the cross-sectional areas of the first flow path 191 and the second flow path 192 may be substantially the same or be different. Furthermore, the number of the flow paths 190 may be more than two. The plurality of flow paths 190 may have different lengths or shapes. In a state in which the nozzle main body 22 is attached to the bottle main body 21, one ends of the flow paths 190 are the base end portion of the nozzle 110 and communicate with the bottle main body 21 through a first opening 193 and a third opening 195. The other ends of the flow paths 190 are the leading end portion of the nozzle 110 and communicate with the outside of the nozzle main body 22 through the second opening 194 and the fourth opening 196. That is, the first flow path has a space volume with the first opening 193 and the second opening 194 at both ends, and the second flow path has a space volume with the third opening 195 and the fourth opening 196 at both ends. The first opening 193 and the third opening 195 are formed on the same plane at the base end portion. However, the first opening 193 and the third opening 195 may be formed on different surfaces. The second opening 194 and the fourth opening 196 are formed at the leading end portion 115 of the nozzle 110.

The second opening 194 and the fourth opening 196 are circular in shape. It should be noted that the second opening 194 and the fourth opening 196 may have a shape other than a circle.

The leading end portion 115 of the nozzle 110 is a portion of the nozzle 110 formed of, for example, the leading end surface and the outer circumferential surface. The nozzle 110 has a recessed portion 116 in the outer circumferential surface thereof. The recessed portion 116 is defined by the leading end surface and an inner circumferential surface 118 (one of the side surfaces) of a circular rib 117 that projects to the first orientation side 134 from the outer edge of the leading end surface. That is, the leading end surface is recessed from the leading end (the leading end of the circular rib 117) of the nozzle 110. The inner circumferential surface 118 extends toward the outer edge of the leading end surface with distance from the leading end surface to the first orientation side 134. That is, the inner circumferential surface 118 extends to the first orientation side 134 while being inclined in a direction that increases the diameter of the recessed portion 116. It should be noted that the inner circumferential surface 118 may also extend to the first orientation side 134 without being inclined. In addition, the nozzle 110 does not need to have the recessed portion 116. That is, the leading end portion of the nozzle 110 does not need to be recessed.

### Supplying Ink

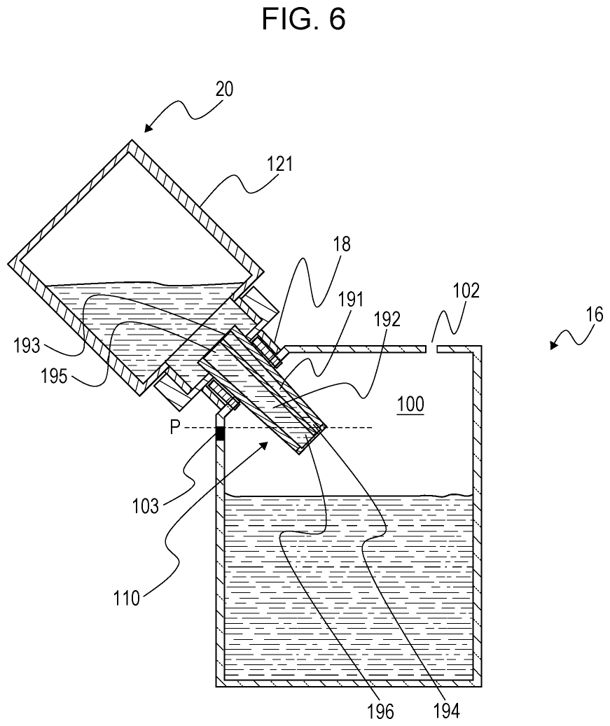

As illustrated in FIG. 6, the nozzle 110 of the ink storage bottle 20 is inserted into the opening portion 18, from which the liquid is injected, of the liquid tank 16, and accordingly, the ink storage bottle 20 is connected to the liquid tank 16. The posture of the ink storage bottle 20 with the ink storage bottle 20 connected to the liquid tank 16 is also referred to as the connection posture. The posture of the ink storage bottle 20 can be defined such that a mark 24 (see FIG. 4) on the nozzle main body 22 faces vertically upward side when the nozzle 110 of the ink storage bottle 20 is inserted into the opening portion 18 of the liquid tank 16.

That is, when the second opening 194 and the fourth opening 196 are located in the storage chamber 100, one of the second opening 194 and the fourth opening 196 can be located vertically above the other. In the present embodiment, the second opening 194 is located above the fourth opening 196 in the connection posture. When the ink storage bottle 20 is connected to the liquid tank 16 and the second opening 194 and the fourth opening 196 are located in the storage chamber 100 of the liquid tank 16, the bottle main body 21 communicates with the storage chamber 100 through the flow path 190. In the connection posture in FIG. 6, ink is supplied from the ink storage bottle 20 to the liquid tank 16 by a so-called chicken feed method.

That is, when the ink storage bottle 20 is connected to the liquid tank 16 and the second opening 194 and the fourth opening 196 are located in the storage chamber 100 of the liquid tank 16, the bottle main body 21 communicates with the storage chamber 100 through the first flow path 191 and the second flow path 192. As a result, the ink stored in the bottle main body 21 flows into the second flow path 192 through the third opening 195 and then flows into the storage chamber 100 through the fourth opening 196.

In addition, as the ink flows, air enters the storage chamber 100 through the atmospheric communication port 102 and flows into the bottle main body 21 through the first flow path 191. Here, the volume of the ink flowing into the storage chamber 100 from the bottle main body 21 is substantially the same as the volume of air flowing into the bottle main body 21 from the storage chamber 100. As described above, gas-liquid exchange is performed. When the ink flows into storage chamber 100 and the ink level in the storage chamber 100 rises to the height of the opening 196, that is, the ink level reaches the height (dashed line position P) of a marker 103, a flow of air between storage chamber 100 and bottle main body 21 through first flow path 191 is blocked. Accordingly, the flow of the ink from the bottle main body 21 to the storage chamber 100 is stopped.

The ink can also be supplied from the ink storage bottle 20 to the storage chamber 100 by using a method that deforms the side wall 121 of the bottle main body 21 of the ink storage bottle 20 in addition to the chicken feed method described above.

### First Embodiment

As described earlier, the first flow path 191 and the second flow path 192 in the nozzle main body 22 of the ink storage bottle 20 are long tubes. When the cross-sectional areas of the first flow path 191 and the second flow path 192 are the same with each other, the ink refill speed may become slower when the ink is supplied from the ink storage bottle 20 to the liquid tank 16. As a result, there is a concern that it takes time to supply the ink to the liquid tank 16.

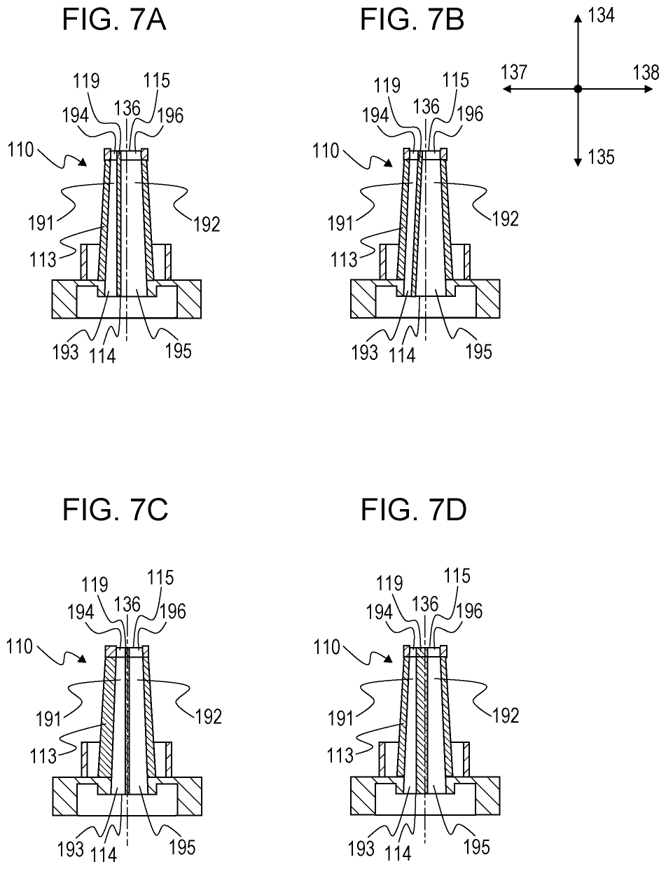

On the other hand, in the present embodiment, of the two flow paths provided in the nozzle 110 of the ink storage bottle 20, the flow path resistance of one flow path portion is smaller than that of the other flow path portion, as illustrated in the cross-sectional views in FIGS. 7A to 7D. The flow path resistance refers to a frictional force caused in a direction opposite to the flow between the liquid and the inner wall of the flow path and is mainly determined by the shape. The flow path resistance is proportional to the length in the direction in which the liquid flows and inversely proportional to the cross-sectional area of the flow path. The space volume of one flow path is made wider than that of the other flow path to create a difference in the flow path resistance.

Specifically, the space volume of the second flow path 192 located on the downward side in the vertical direction is set to be larger than the space volume of the first flow path 191. The space volumes of the first flow path 191 and the second flow path 192 can be set to desirable volumes by adjusting the position of the partition wall 119 that separates the first flow path 191 from the second flow path 192 and the thickness of the outer circumferential wall 113. The third opening 195 is wider than the first opening 193 in the second flow path 192, and the space volume communicating with the base end portion 114 of the flow path is larger. As a result, a larger amount of ink flows into the second flow path 192 through the third opening 195 when the ink storage bottle 20 is tilted to the ink refill posture, and accordingly, the ink refill speed is improved. In addition, the opening area of the third opening 195 that communicates with the ink storage bottle 20 is larger than the opening area of the first opening 193, and the space volume that communicates with the base end portion 114 is larger. The flow path portion is a long tube that extends from the base end portion 114 to the leading end portion 115. When the ink flows from the third opening 195 toward the fourth opening 196 to supply the ink, the momentum of ink flowing from the ink storage bottle 20 to the third opening 195 applies a force for pushing ink from the base end portion 114 toward the leading end portion 115. As a result, the ink refill speed can be further improved.

As illustrated in FIGS. 7A and 7B, the partition wall 119 that separates the first flow path 191 from the second flow path 192 can be provided. That is, the third opening 195 of the second flow path 192 can be made wider than the first opening 193 by the partition wall 119 being shifted toward the first flow path, that is, in the first direction 137, with respect to the center axis 136 of the nozzle 110. The partition wall 119 may be provided vertically in parallel to the center axis 136 or may be provided so as to be inclined with respect to the center axis 136 to make the third opening 195 as wide as possible.

In FIG. 7C, the space volume of the second flow path 192 is made larger than the space volume of the first flow path 191 by adjusting the thickness of the outer circumferential wall 113 that constitutes the first flow path 191. In FIG. 7D, the thickness of partition wall 119 that separates the first flow path 191 from the second flow path 192 is changed to make the space volume of the second flow path 192 larger than the space volume of the first flow path 191, thereby making a difference between the space volumes of the two flow paths.

The difference between the flow path resistances of the two flow paths, which are the first flow path 191 and the second flow path 192, preferably significantly differs from each other for sufficient improvement of the ink refill speed, which is the effect of the present disclosure, when the ink is injected. However, the opening areas of the first opening 193 and the second opening 194 provided at both ends of the first flow path 191 are preferably large enough to cause air to flow into the bottle main body 21. Accordingly, the difference between the flow path resistances of the two flow paths can be 1.2 and 10 times. The difference between the flow path resistances of the two flow paths can be 2 to 5 times to efficiently dispose the flow paths in the nozzle main body 22.

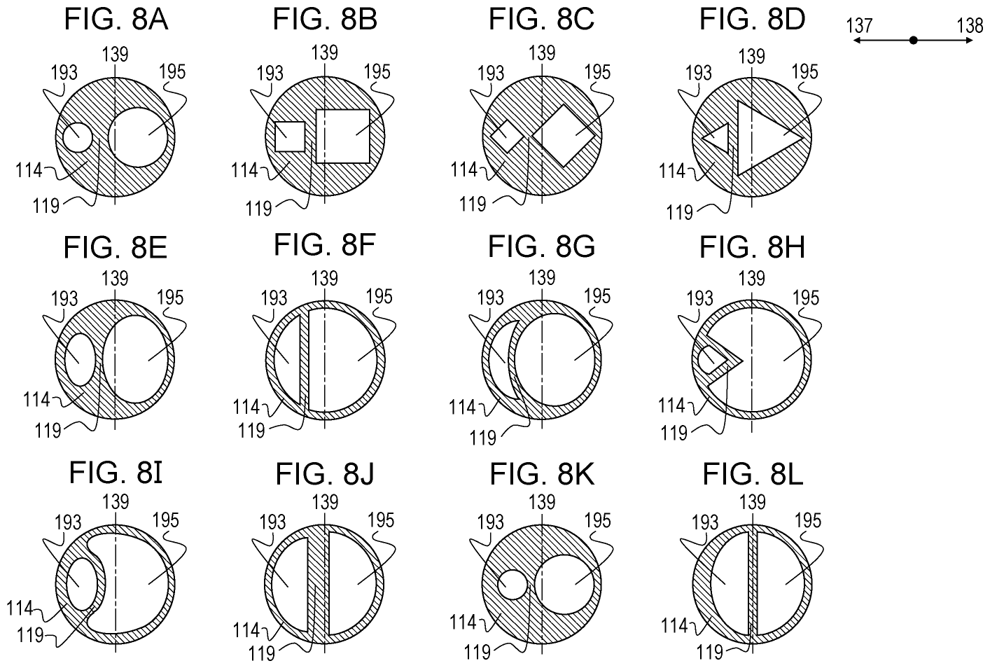

Examples of the shapes of openings of the two flow paths disposed at the base end portion 114 are illustrated in FIGS. 8A to 8L. The first opening 193 and the third opening 195 may have the same shape and different sizes as illustrated in FIGS. 8A to 8E and FIG. 8K or may have different shapes as illustrated in FIGS. 8F to 8J and FIG. 8L. The cross section of the liquid supply unit, orthogonal to the center axis 136 along the direction in which the liquid in the liquid supply unit flows, that passes through the center axis 136 can be divided into two regions with respect to the center line 139. The opening portions are provided such that the area of the third opening 195 closer to the side of the second direction 138 is larger than the opening area of the first opening 193 closer to the side of the first direction 137 with reference to the center line 139. The openings with different shapes can make the opening area of the third opening 195 larger and increase the amount of the ink flowing into the second flow path 192. In addition, the first opening 193 at the base end portion 114 and the second opening 194 at the leading end portion 115, as well as the third opening 195 at the base end portion 114 and the fourth opening 196 at the leading end portion 115 may have the same shape or different shapes that vary from the base end portion 114 toward the leading end portion 115.

The mark 24 may be provided on the nozzle main body 22 to define the connection posture of the ink storage bottle 20 such that the nozzle 110 is inserted into the opening portion 18 to position the second flow path 192 on the downward side in the vertical direction of the first flow path 191. As long as the operator can be guided to define the positional relationship between the first flow path 191 and the second flow path 192 in the connection posture, a method other than this may be used.

### Second Embodiment

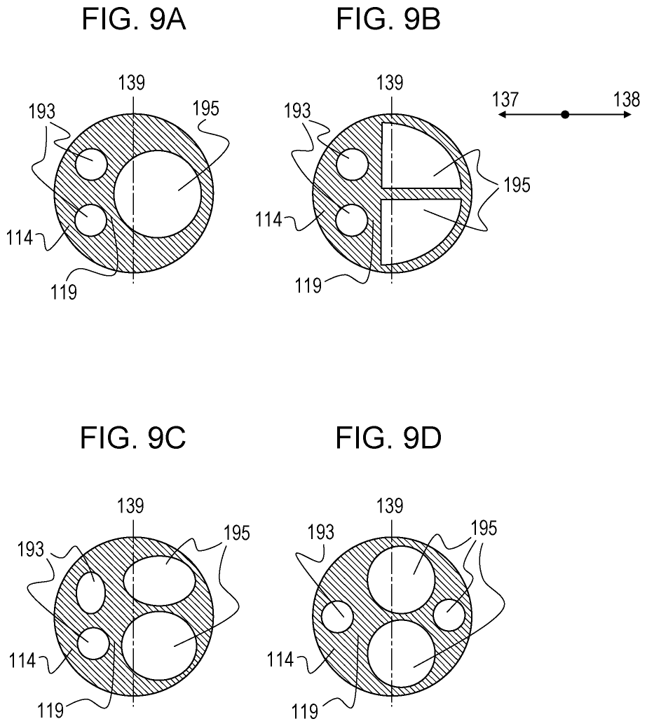

FIGS. 9A to 9D illustrate examples of the shapes of openings disposed at the base end portion 114 when the plurality of first flow paths 191 and the plurality of second flow paths 192 are present. When a plurality of flow paths is present, these flow paths are disposed such that the total space volume of the plurality of second flow paths through which the liquid flows is larger than the total space volume of the plurality of first flow paths 191 through which the gas flows. The opening portions are provided such that the total opening area of the third opening 195 closer to the side of the second direction 138 is larger than the total area of the first openings 193 closer to the side of the first direction 137 with reference to the center line 139. Since the plurality of first flow paths 191 through which the gas flows is present in FIG. 9A, the plurality of first openings 193 is provided. Since the diameter of the cross-sectional area of the first flow path 191 through which the gas flows is smaller than that of the second flow path 192, the ink cannot be supplied if the liquid enters and blocks the flow path. Since the plurality of first flow paths 191 is present, even if one of them is blocked, the ink can be supplied because the gas flows through another flow path. Since the plurality of first flow paths 191 and the plurality of second flow paths 192 are present in FIGS. 9B and 9C, the plurality of first openings 193 and the plurality of third openings 195 are present. Even if a flow path through which the gas or the liquid flows is blocked at one position, the ink can be supplied because gas-liquid exchange can be performed in a remaining flow path. Since the plurality of second flow paths 192 through which the liquid flows is present in FIG. 9D, the plurality of third openings 195 is provided. Even if one of the second flow paths 192 through which the liquid flows is blocked, the liquid can be supplied by using another flow path.

### Third Embodiment

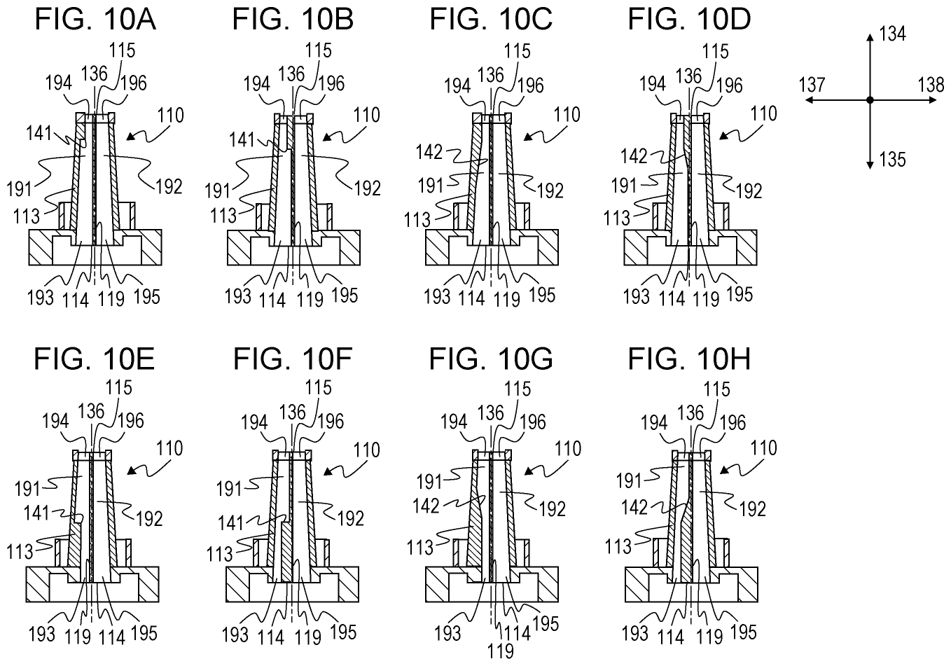

FIGS. 10A to 10H illustrate another embodiment in which the position of the partition wall 119 that separates the first flow path 191 from the second flow path 192 and the thickness of the outer circumferential wall 113 are adjusted to make the space volume of the second flow path 192 larger than the space volume of the first flow path 191. Specifically, the cross-sectional area of the flow path portion can be partially reduced. A step is provided between the first opening 193 and the second opening 194 of the first flow path 191. A slope 142 may be formed instead of the step. In FIGS. 10A to 10D, the opening area of the second opening 194 provided closer to the leading end portion 115 of the nozzle 110 is smaller than that of the fourth opening 196. Since the amount of air taken in at the start of gas-liquid exchange is small to supply ink, the ink is supplied gently. Once gas-liquid exchange begins, since the flow speed of air is high, air is transported to the ink storage bottle 20 through the first flow path 191. In the second flow path 192, the third opening 195 at the base end portion 114 is wider than the fourth opening 196 at the leading end portion 115. Accordingly, the momentum of the ink flowing from the ink storage bottle 20 into the second flow path 192 makes the ink refill speed faster. At the moment at which supply of ink from ink storage bottle 20 starts, the ink is discharged gently, the ink can be suppressed from adhering to the nozzle 110. In FIGS. 10E to 10H, the opening area of the first opening 193 closer to the base end portion 114 of the nozzle 110 is smaller than that of the third opening 195. Since the opening area of the first opening 193 located on the first orientation side 134 is small while the ink storage bottle 20 is tilted to the refill position, the ink is less likely to be injected through the first opening 193. Even if the ink is injected, the amount is small. Even if the injected ink is formed as a liquid film near the first opening 193, since air flows through the second opening 194, which has a larger than the first opening 193, after gas-liquid exchange starts, an ink film can be easily broken. As a result, gas-liquid exchange is smoothly started. When the opening area of the first opening 193 is adjusted by the thickness of the partition wall 119 as illustrated in FIGS. 10B and 10D, the first opening 193 can be disposed at a high position closer to the first orientation side 134 when the ink storage bottle 20 is tilted to a storage posture.

### Fourth Embodiment

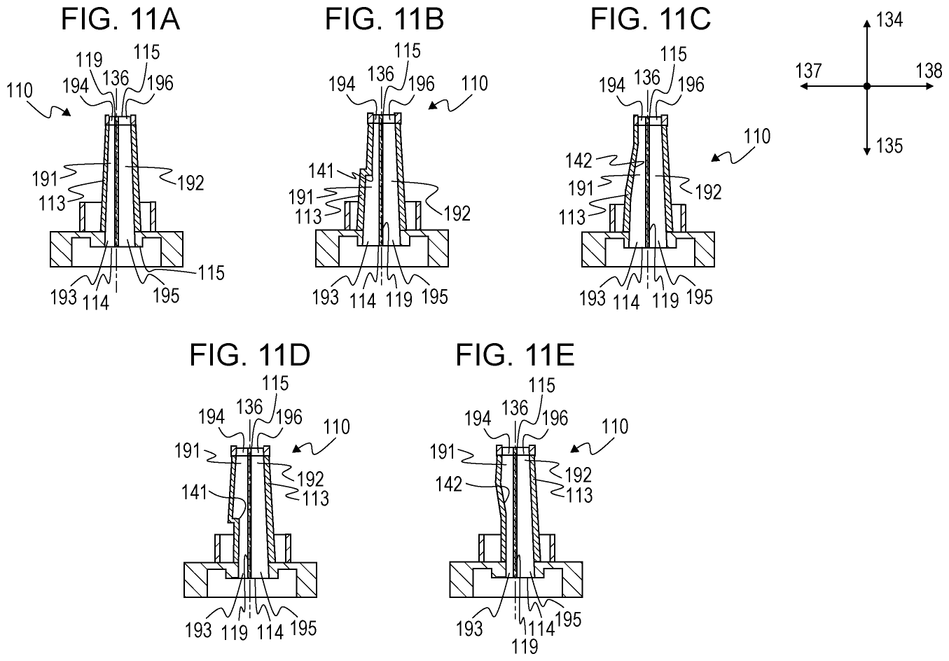

FIGS. 11A to 11E illustrate examples of an embodiment in which the space volume of the first flow path 191 is smaller than the space volume of the second flow path 192. Specifically, as illustrated in FIG. 11A, the partition wall that separates the first flow path 191 from the second flow path 192 is disposed so as to be aligned with the center axis 136 along a direction in which the liquid in the liquid supply unit flows, but the outer circumferential wall 113 that constitutes the first flow path 191 is brought closer to the center axis 136. Alternatively, the flow path is narrowed by a portion of the outer circumferential wall 113 that constitutes the first flow path 191 being brought closer in the direction of the center axis 136. In FIGS. 11B and 11C, the first flow path 191 is narrowed toward the leading end portion 115 of the nozzle 110 with a step or an inflection point set as a reduction starting point 141 of the flow path. In FIGS. 11D and 11E, the first flow path 191 is narrowed toward the base end portion 114 of the nozzle 110 with a step or an inflection point set as the reduction starting point 141 of the flow path. By denting at least a portion of the nozzle 110 to the inside, at least a portion of the inner wall of the first flow path can be expanded into the space of the first flow path. As a result, the space volume of the second flow path 192 becomes larger than the space volume of the first flow path 191. As a result, it is possible to make a difference between the space volumes of the first flow path 191 and the second flow path 192 without significantly deforming the outer shape of nozzle 110.

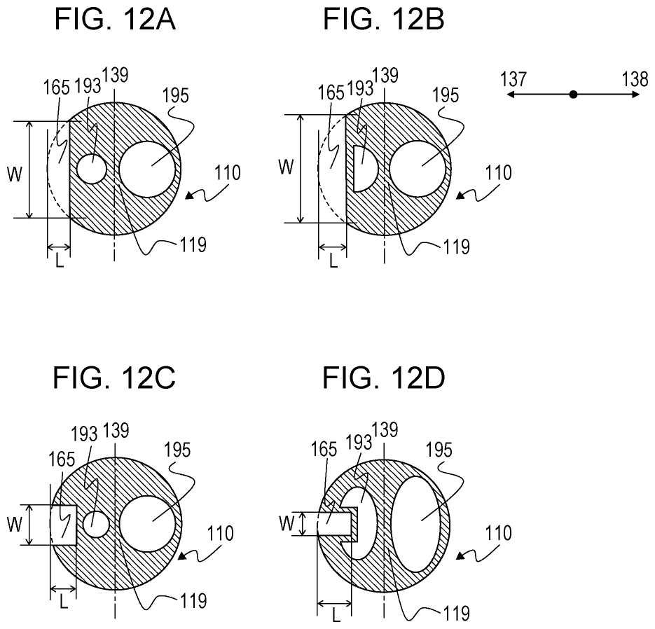

FIGS. 12A to 12D illustrate examples of cross-sectional views of the nozzle 110 exemplified in FIGS. 11A to 11E. A recessed portion 165 formed by denting at least a portion of the nozzle 110 to the inside may have a shape formed by partially cutting out a circle on the cross-section of the nozzle 110, as illustrated in FIGS. 12A and 12B. As illustrated in FIGS. 12C and 12D, the recessed portion 165 may have a notched shape. The notched shape is defined by the width W and the distance L toward the center line 139 of nozzle 110. The notched shape may be a rectangle, a triangle, a trapezoid, a semicircle, an ellipse, or the like but is not limited to these shapes as long as the notched shape is formed by at least a portion thereof is internally recessed. The recessed portion 165 can be disposed on the circumference of the outer circumferential surface within a range of ±90° with the second direction 138 set as the starting point. The recessed portion 165 can be disposed within a range of ±45° with the first direction 137 set as the starting point.

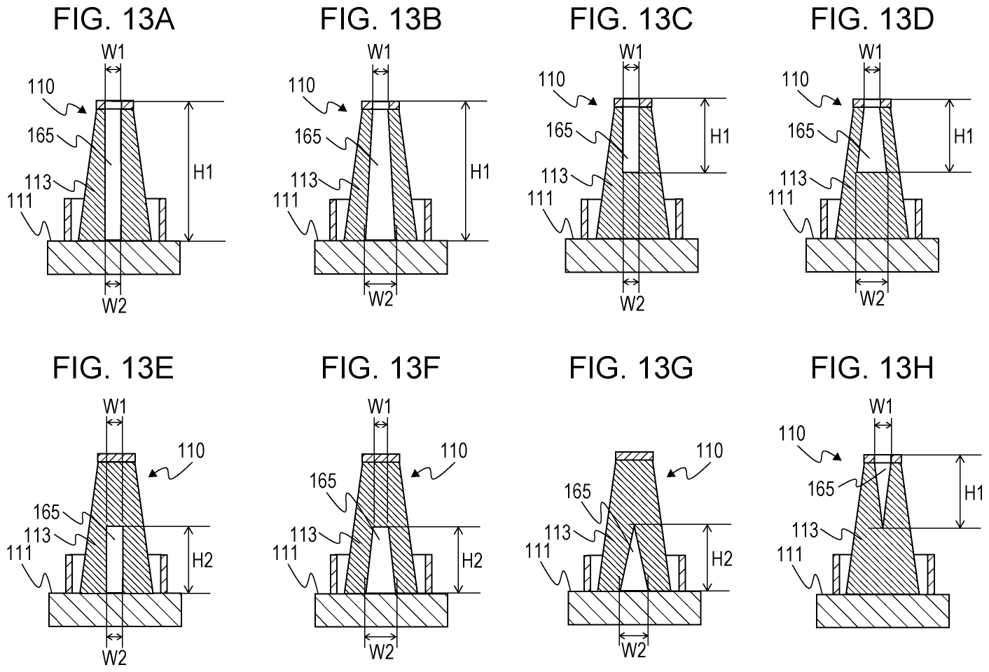

FIGS. 13A to 13H are examples of front views of the nozzle 110 having the recessed portion 165 when the first flow path 191 faces the front. The recessed portion 165 is defined by combination of the width W, the length L of the recess, and heights H1 and H2. Specifically, the shape is obtained by removing a portion of a structure, such as a cuboid, a cylinder, a triangular pyramid, a quadrangular pyramid, a cone, or a quadrangular truncated pyramid, from the first flow path 191. The recessed portion 165 is not limited to these as long as the space volume of the second flow path 192 is larger than the space volume of the first flow path 191. The recessed portion 165 described above may also be a portion of a connection portion that engages the opening portion of the liquid tank when the nozzle is connected to the opening portion to supply ink.

### Fifth Embodiment

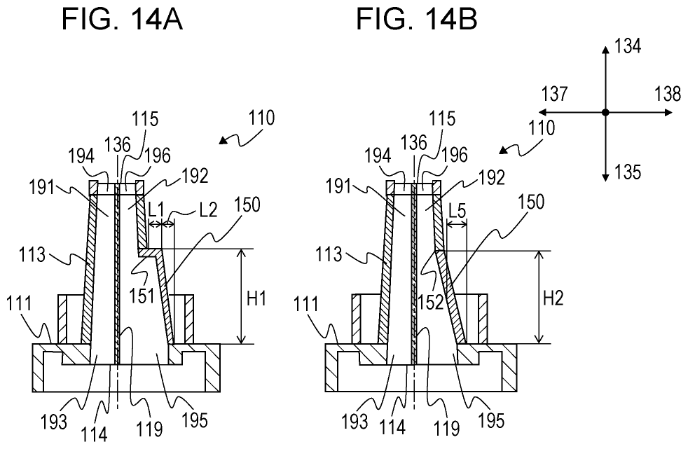

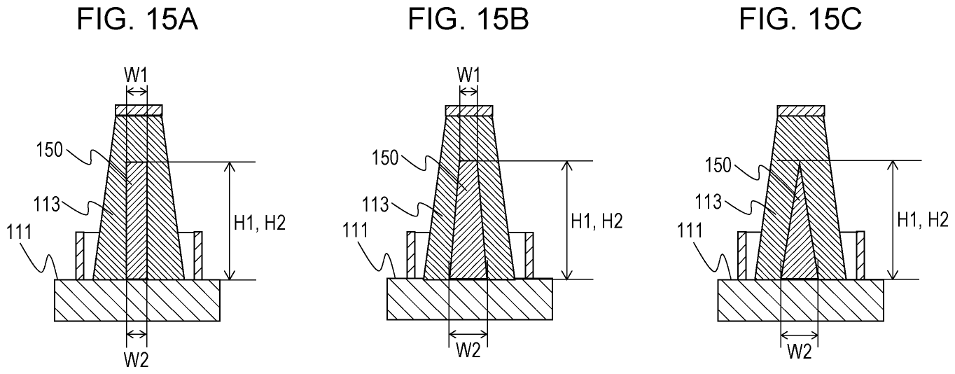

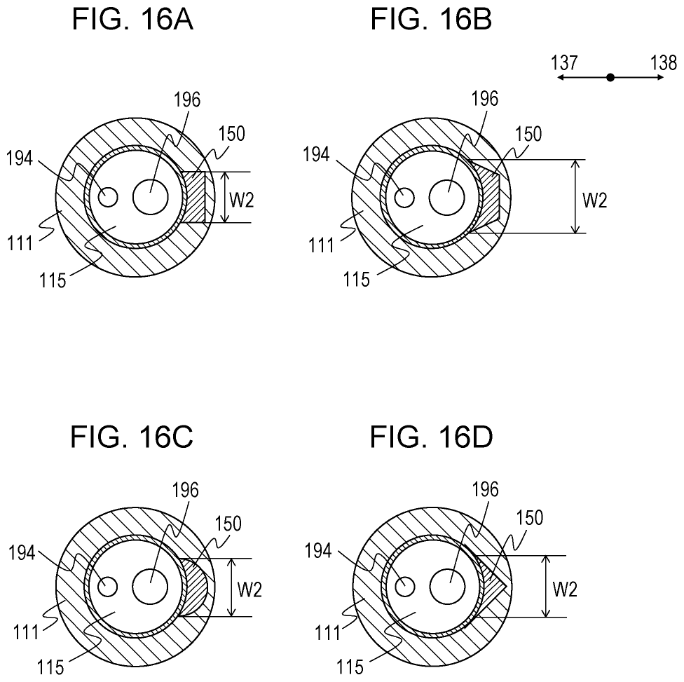

FIGS. 14A and 14B illustrate examples in which an overhanging projecting portion 150 projecting in the second direction 138 is provided on a portion of the outer circumferential wall 113 that constitutes the second flow path 192 to make the space volume of the second flow path 192 larger than the space volume of the first flow path 191. The overhanging projecting portion 150 is disposed to project to the outside with a step illustrated in FIG. 14A or an inflection point illustrated in FIG. 14B set as a starting point 151 for expanding the flow path. FIGS. 15A to 15D illustrate examples of front views of the nozzle 110 having the projecting portion 150 when the second flow path 192 faces the front. FIGS. 16A to 16D are plan views of the nozzle 110 as seen from the leading end portion 115. The projecting portion 150 is defined by the heights H1 and H2, the lengths L1, L2, and L5 of overhangs in the second direction 138 from the outer circumferential surface, and widths W1 and W2 of projections. Specifically, the shape is formed by combining a portion of a structure, such as a cuboid, a cylinder, a triangular pyramid, a quadrangular pyramid, a cone, or a quadrangular truncated pyramid, with the second flow path 192. The projecting portion 150 is not limited to these as long as the space volume of the second flow path 192 is larger than the space volume of the first flow path 191. The overhanging projecting portion 150 may also be a portion of the connection portion that engages the opening portion of the liquid tank when the nozzle is connected to the opening portion to supply ink. The projecting portion 150 can be disposed on the circumference of the outer circumferential surface within a range of ±90° with the second direction 138 set as the starting point. The projecting portion 150 is disposed within a range of ±45° with the second direction 138 set as the starting point. The opening area of the third opening 195 can be made wider by the projecting portion 150 being disposed in the second flow path 192. As a result, the amount of ink flowing from the third opening 195 to the second flow path 192 can be increased in the ink refill posture, and accordingly, the ink refill speed can be increased.

### Sixth Embodiment

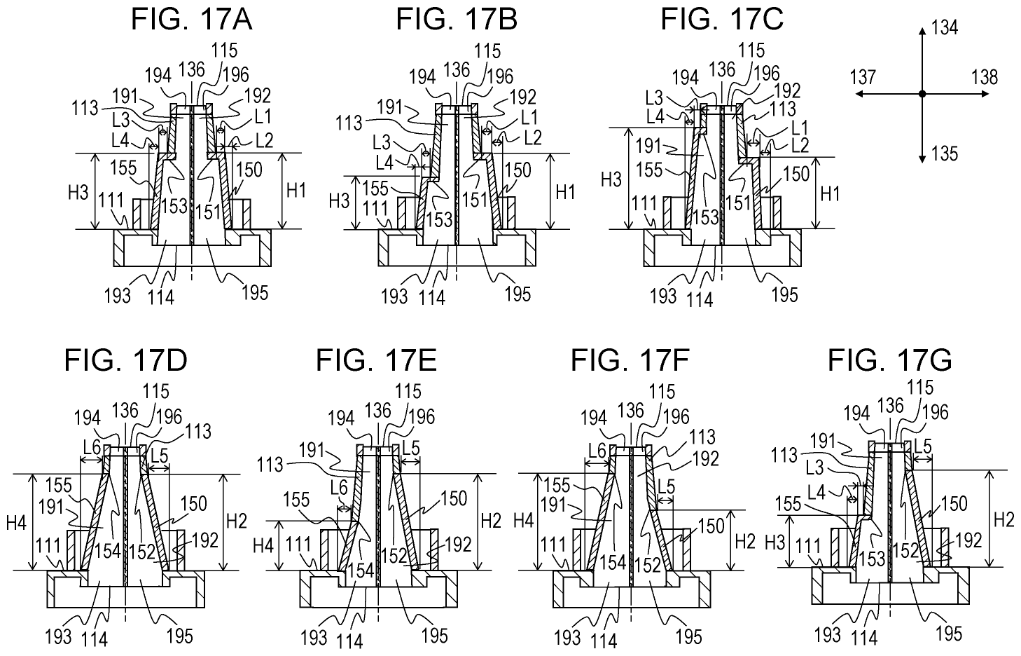

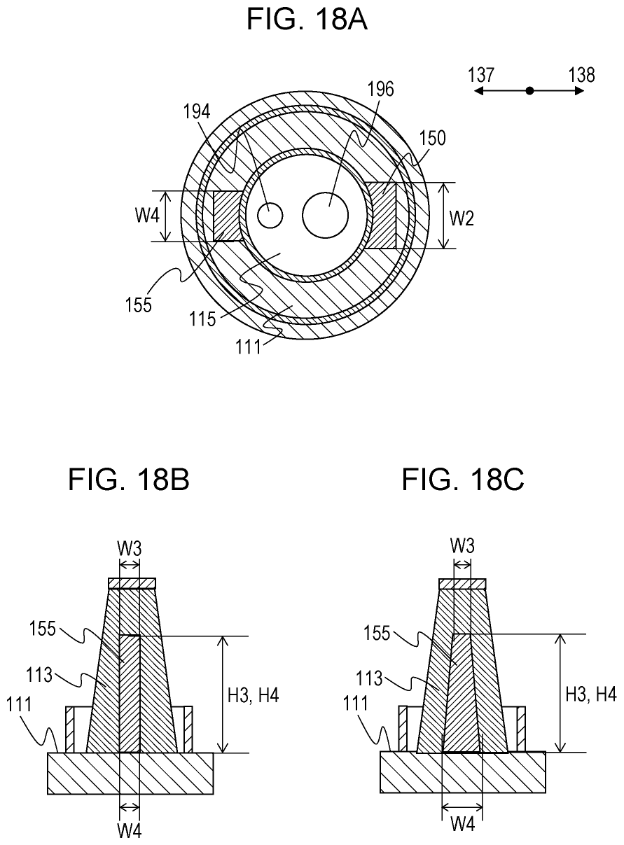

As illustrated in FIGS. 17A to 17G, an additional projecting portion 155 that expands the first flow path 191 may be provided in addition to the projecting portion 150 that expands the second flow path 192. When the ink storage bottle 20 takes the connection posture, the projecting portions 150 and 155 are disposed such that the second flow path 192 is located on the downward side in the vertical direction and the space volume of the second flow path 192 is larger than the space volume of the first flow path 191. Similar to the projecting portion 150, the additional projecting portion 155 is disposed to overhang to the outside with steps illustrated in FIGS. 17A to 17C or inflection points illustrated in FIGS. 17D to 17F set as starting points. The lengths of overhangs in the first direction 137 from the outer circumferential surface are defined as L3, L4, and L6. As illustrated in FIG. 17G, the combination of structures in which the projecting portions 150 and 155 overhang at a step and an inflection point is allowed and the combination is not limited to this. FIGS. 18A to 18C illustrate an example of a plan view of the nozzle 110 as viewed from the leading end portion 115 and examples of front views of the additional projecting portion 155. The additional projecting portion 155 is defined by combination of the heights H3 and H4 and widths W3 and W4 of the overhanging additional projecting portion 155. Specifically, the shape is formed by combining a portion of a structure, such as a cuboid, a cylinder, a triangular pyramid, a quadrangular pyramid, a cone, or a quadrangular truncated pyramid with the first flow path 191 but not limited to this. The additional projecting portion 155 can be disposed on the circumference of the outer circumferential surface within a range of ±90° with the first direction 137 set as the starting point. The additional projecting portion 155 can be disposed within a range of ±45° with the first direction 137 set as the starting point.

### Seventh Embodiment

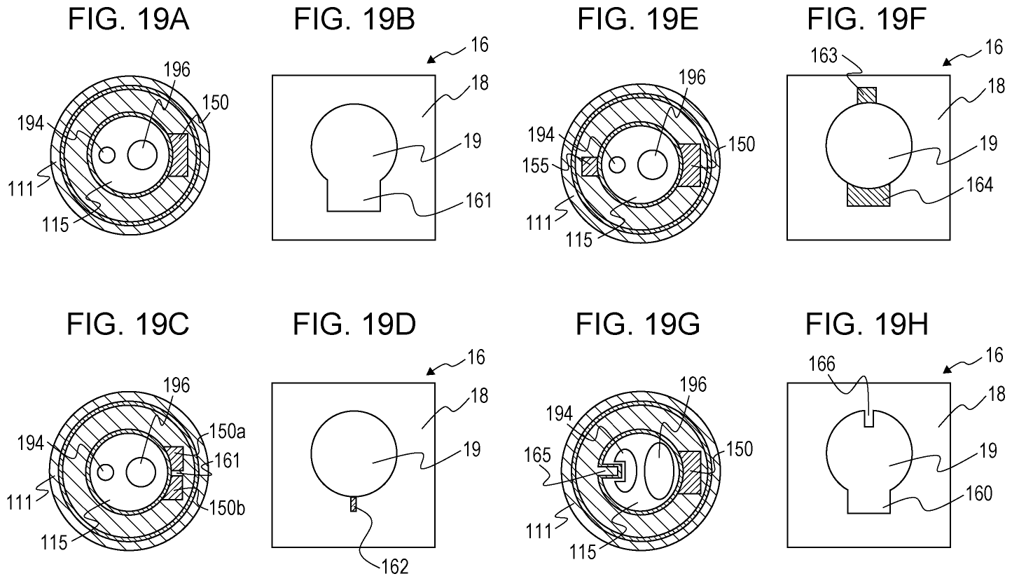

The projecting portion 150 and the additional projecting portion 155 provided on the outer circumferential surface of the nozzle 110 may also serve as a positioning mechanism for connecting the ink storage bottle 20 to the storage chamber 100 of the liquid tank 16. The projecting portion 150 and the additional projecting portion 155 are cuboids here, but the shape is not limited to this. As illustrated in FIGS. 19A to 19H, the opening 19 of the opening portion 18 of the storage chamber 100 to which the ink storage bottle 20 is connected has a shape that fits to the nozzle 110. As a result, the ink refill posture can be defined by using the projecting portion 150 or both the projecting portion 150 and the additional projecting portion 155. In the keyhole shape illustrated in FIGS. 19A and 19B, a pull-out hole 161 into which the projecting portion 150 is inserted is provided in the opening 19.

As illustrated in FIGS. 19C and 19D, a gap between a plurality of projecting portions 150a and 150b may be fixed by clamping a projection 162 provided in the opening 19. As illustrated in FIGS. 19E and 19F, a receiving portion 163 and an additional receiving portion 164 are provided in the opening portion 18 such that the projecting portion 150 and the additional projecting portion 155 can be fitted into and abut against the receiving portion 163 and the additional receiving portion 164. As illustrated in FIGS. 19G and 19H, a convex portion 166 and the pull-out hole 161 may be provided in the opening portion 18 so as to engage the recessed portion 165 and the additional projecting portion 155. Only one example is described here, the present disclosure is not limited to this, and any combination is enabled. When the connection posture of the ink storage bottle 20 is defined by the mark 24 on the nozzle main body 22, the user may manually adjust the posture after visual confirmation. Since the connection posture is adjusted manually, the first flow path 191 may deviate from its normal position located in an upper portion in the vertical direction of the second flow path 192 due to misrecognition of the mark 24 or error in manual adjustment of the posture position. Since the shape of the nozzle 110 physically defines the ink refill posture of the ink storage bottle 20 in the present embodiment as illustrated in FIGS. 19A to 19H, the user can make connection to the storage chamber 100 at a correct position even when misrecognizing the mark 24. In addition, since the second flow path 192 is always located on the downward side in the vertical direction by providing the projecting portion 150 to make the space volume of the second flow path 192 through which ink flows larger than the space volume of the first flow path 191, a larger amount of ink flows from the ink storage bottle 20 to the second flow path 192.

As a result, both definition of the ink refill posture and an increase in the ink refill speed can be achieved.

### Eighth Embodiment

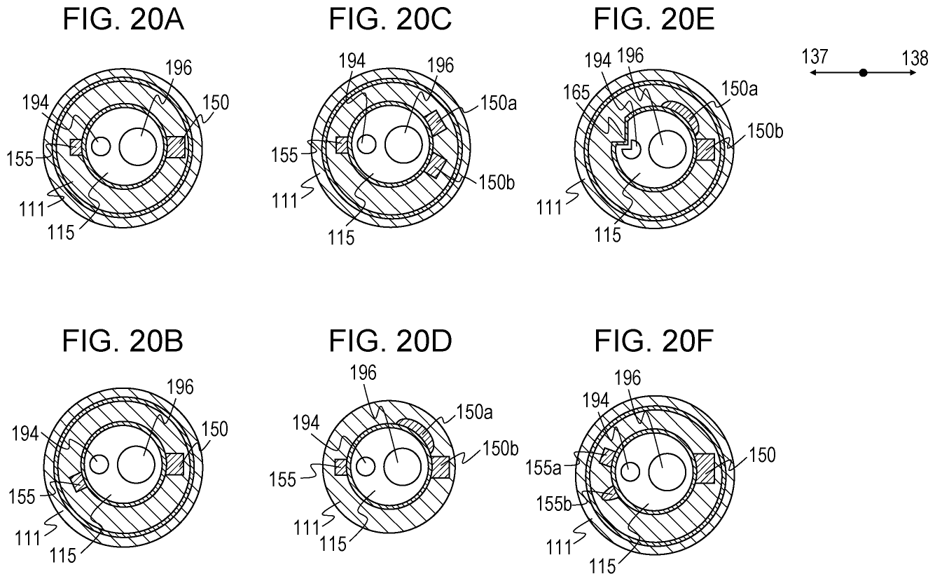

When there is a plurality of liquid tanks 16, different combinations may be set in the storage chambers 100 such that the shapes of the projecting portions 150 and 155 and the recessed portions 165 provided in the ink storage bottle 20 fit to the shape of the opening 19 of the opening portion 18 of the storage chamber 100. An example is illustrated in FIGS. 20A to 20E. When a plurality of different types of ink is used, combination in which the shape of the projecting portion 150 fits to the shape of the opening 19 of the opening portion 18 of the storage chamber 100 can be changed for each type of ink. For example, it is possible to adopt a combination in which the position of the projecting portion 150 provided in the second flow path 192 is the same, but the position of the additional projecting portion 155 provided in the first flow path 191 is different, as illustrated in FIG. 20A and FIG. 20B. As illustrated in FIGS. 20C and 20D, the position of the additional projecting portion 155 provided in the first flow path 191 may be the same, and the combination of the shapes and arrangement of the projecting portions 150a and 150b provided in the second flow path 192 may be changed. As illustrated in FIGS. 20E and 20F, the recessed portion 165, the projecting portions 150 (150a and 150b), and the additional projecting portions 155 (155a and 155b) may be freely combined with each other. As described above, by changing the combination of the projecting portions 150 and 155, the recessed portion 165, and the opening 19 for each liquid when the user supplies the ink from the ink storage bottle 20 to the storage chamber 100, the user can avoid wrong insertion of the liquid storage bottle 200, thereby improving operability.

The embodiments described above may be combined as appropriate.

According to the present disclosure, since the amount of liquid supplied from the ink storage bottle to the liquid tank per unit time increases, the refill speed is improved, and the refill time can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-032737, filed Mar. 5, 2024, which is hereby incorporated by reference herein in its entirety.

What is claimed is:

1. A liquid storage bottle that supplies a liquid to a recording device including a recording head that discharges the liquid, and a liquid tank that includes a storage unit that stores the liquid supplied to the recording head and an opening portion through which the liquid is suppled, the liquid storage bottle comprising:
a bottle main body that stores the liquid; and
a liquid supply unit including a second flow path through which the liquid flows from the bottle main body to the liquid tank, the second flow path being connected to the opening portion of the liquid tank, and a first flow path through which a gas flows from the liquid tank to the bottle main body,
wherein a flow path resistance of the first flow path is greater than a flow path resistance of the second flow path.

2. The liquid storage bottle according to claim 1,
wherein a flow path resistance of the first flow path is 1.2 to 10 times a flow path resistance of the second flow path.

3. The liquid storage bottle according to claim 2,
wherein the flow path resistance of the first flow path is 2 to 5 times a flow path resistance of the second flow path.

4. The liquid storage bottle according to claim 1,
wherein a length of the first flow path is substantially identical to a length of the second flow path, and a cross-sectional area of the second flow path is larger than a cross-sectional area of the first flow path.

5. The liquid storage bottle according to claim 1,
wherein a connection posture is defined such that a projecting portion or a recessed portion of the liquid supply unit engages the opening portion and the first flow path is located vertically above the second flow path.

6. The liquid storage bottle according to claim 5,
wherein the projecting portion or the recessed portion of the liquid supply unit varies depending on a type of the liquid.

7. The liquid storage bottle according to claim 5,
wherein the liquid supply unit has a positioning indication that defines the connection posture.

8. The liquid storage bottle according to claim 1,
wherein at least one of the first flow path and the second flow path includes a plurality of flow paths.

9. A recording device comprising:
the liquid storage bottle according to claim 1;
a recording head that performs recording by discharging a liquid; and
a liquid tank, connected through the liquid supply unit, that stores the liquid injected from the liquid storage bottle.

10. The recording device according to claim 9,
wherein the liquid tank has an inclined surface inclined in both a horizontal direction and a vertical direction, and
an opening portion into which the liquid supply unit of the liquid storage bottle is inserted is formed in the inclined surface.

11. The recording device according to claim 9,
wherein the liquid tank has an atmospheric communication port through which an inside of the liquid tank communicates with an atmosphere.

12. An ink refill system with an ink storage bottle in which, when ink is supplied from an ink storage bottle to a storage chamber of a liquid tank, the flow path resistance of a second flow path portion through which the ink flows is less than the flow path resistance of a first flow path portion through which air flows of the two flow path portions provided in a nozzle of the ink storage bottle.

13. The ink refill system according to claim 12, wherein the ink storage bottle comprises a liquid storage bottle that supplies a liquid to a recording device including
a recording head that discharges the liquid, and
a liquid tank that includes a storage unit that stores the liquid supplied to the recording head and an opening portion through which the liquid is suppled,
the liquid storage bottle comprising:
a bottle main body that stores the liquid; and
a liquid supply unit including a second flow path through which the liquid flows from the bottle main body to the liquid tank, the second flow path being connected to the opening portion of the liquid tank, and a first flow path through which a gas flows from the liquid tank to the bottle main body,
wherein a flow path resistance of the first flow path is greater than a flow path resistance of the second flow path.

14. The ink refill system according to claim 13,
wherein a flow path resistance of the first flow path is 1.2 to 10 times a flow path resistance of the second flow path.

15. The ink refill system according to claim 14,
wherein the flow path resistance of the first flow path is 2 to 5 times a flow path resistance of the second flow path.

16. The ink refill system according to claim 13,
wherein a length of the first flow path is substantially identical to a length of the second flow path, and a cross-sectional area of the second flow path is larger than a cross-sectional area of the first flow path.

17. The ink refill system according to claim 13,
wherein a connection posture is defined such that a projecting portion or a recessed portion of the liquid supply unit engages the opening portion and the first flow path is located vertically above the second flow path.

18. The ink refill system according to claim 17,
wherein the projecting portion or the recessed portion of the liquid supply unit varies depending on a type of the liquid.

19. The ink refill system according to claim 17,
wherein the liquid supply unit has a positioning indication that defines the connection posture.

20. The ink refill system according to claim 13,
wherein at least one of the first flow path and the second flow path includes a plurality of flow paths.
